(19) United States
(12) Patent Application Publication
(10) Pub. No.: US 2001/0028411 A1
(43) Pub. Date: Oct. 11, 2001

(54) Moving image reception quality determination apparatus

(76) Inventor: Yoshizou Honda, Kanagawa (JP)

Correspondence Address: Fish & Richardson P.C., 45 Rockefeller Plaza, Suite 2800, New York, NY, 10111, US

(21) Appl. No.: 09/816,919

(22) Filed: Mar. 23, 2001

(30) Foreign Application Priority Data
Mar. 27, 2000 (JP) P. 2000-087601

(51) Int. Cl. H04N 5/44

(52) U.S. Cl. 348/734

(57) ABSTRACT

Moving image reception quality evaluator 4 for evaluating the reception quality of a moving image receiver 31 of the user, moving image reception quality evaluator 5 for evaluating the reception quality of a moving image receiver 32 for receiving the same moving image as the moving image receiver 31, and a determination machine 1 for determining the reception quality of the moving image receiver 31 based on comparison between the evaluation value of the moving image reception quality evaluator 4 and the evaluation value of the moving image reception quality evaluator 5 are provided. A quality provider for managing the moving image reception quality evaluator 4, the moving image reception quality evaluator 5, and the determination machine 1 pays the amount determined based on the reception quality determined by the determination machine 1 to a service provider for providing moving image communication service.

### BACKGROUND OF THE INVENTION

1. Field of the Invention

This invention relates to a moving image reception quality determination apparatus and in particular to a moving image reception quality determination apparatus intended for equitable service charge in digital moving image communication service.

2. Description of the Related Art

Hitherto, “moving image communication quality determination apparatus” in Japanese Patent Application No. Hei 11-153078 by the present inventor has been disclosed as a moving image reception quality determination apparatus. The apparatus will be discussed briefly.

FIG. 3 is a block diagram to show a configuration example of the apparatus in a related art. A moving image transmitter 10 and a moving image receiver 31 are connected to a network 20 and moving image code transmitted by the moving image transmitter 10 is received at the moving image receiver 31.

The digital moving image is a continuous arrangement of instantaneous pictures called frames, and each frame consists of digital data representing color, brightness, or gradation values of a large number of points called pixels into which a display screen is disassembled like a lattice. The above-mentioned moving image code is a bit string provided by compressing the original digital moving image information and the moving image transmitter 10 and the moving image receiver 31 transmit and receive the moving image code.

The international standards of moving image code are, for example, MPEG (Moving Picture Experts Group)-2 (ISO/IEC-13818) and MPEG-4 (ISO/IEC-14496) according to ISO (International Organization for Standardization) and IEC (International Electrotechnical Commission) and H.261, H263, etc., according to ITU (International Telecommunication Union) Recommendations. They are also applied to moving image code using systems equivalent to the coding systems used in the international standards.

If a transmission error, data discard, a delay, or the like occurs in transmission of moving image code, the image of the part corresponding to the error, etc., cannot be decoded at the receiving party. To send a digital moving image, the moving image code of one frame after another is sent and smooth motion is reproduced only by displaying the frames at time intervals determined on decode display of the moving image receiver. Thus, the moving image code not normally arriving at the moving image receiver by the time the determined time is reached is discarded for the next decode display.

Assuming that the decode display of the following frame is normal, an incomplete decode image is displayed as the preceding frame or the frame itself is not displayed and subsequently the normally decoded frame is again displayed. In such a case, visually the motion may seem to stop or seem to be jerky. Such a phenomenon is called “frame display skip” or “freeze,” which will be hereinafter called display skip.

Here, for simplicity, an example wherein a display skip occurs due to a transmission error, data discard, a delay, or the like and causes the moving image reception quality to be degraded will be discussed. An example of reception quality degradation because of any other cause is described in Japanese Patent Application No. Hei 11-153078 mentioned above and is not essentially different from the reception quality degradation caused by the display skip due to a transmission error, etc., for the invention and will not be discussed again.

Moving image reception quality evaluation means 4 in FIG. 3 detects a display skip occurring in the moving image receiver 31. Specifically, it counts the number of times a display skip has occurred per unit time. This value is an example of a moving image reception quality evaluation value.

A problem involved in a service provider for providing moving image communication service for the user who wants to use the service will be discussed. It is generally difficult to predict occurrence of degradation of the quality at the receiving time of a moving image provided by the moving image communication service, such as the above-mentioned transmission failure. Then, to collect the service charge from the user, a quality level contract of charging in response to the total service quality during good and poor times throughout a specific period, such as one month, is available. For simplicity, a contract of collecting a constant charge monthly and returning the charge in response to occurrence of quality degradation is also assumed to be equivalent to that contract.

In such a quality level contact, the charge is determined based on the record indicating the extent to which the quality is over what time period, and therefore it is extremely important to calculate the moving image reception quality evaluation value.

However, taking a display skip as an example, even a partially incomplete image as described above is not included in the display skip count if frame display is produced although the quality is clearly degraded.

Further, if a display skip occurs at the instant at which originally the subject stops, the quality is not degraded, but if a display skip occurs at the instant at which communication of motion of the subject is important, remarkable quality degradation can occur. This means that the equal display skip count does not necessarily represent equal moving image reception quality. Thus, the fact that the evaluation value cannot completely represent the moving image reception quality is also applied to the evaluation scale other than the display skip; it is difficult to completely represent the moving image reception quality based on a single evaluation scale. In fact, several representative evaluation scales like the display skip in the example are used to evaluate the moving image reception quality with limited accuracy.

The example wherein the moving image reception quality is degraded due to transmission factors has been described. In addition, an anomaly in the moving image transmitter, the moving image receiver, or the moving image reception quality evaluation means also causes an evaluation value difference to occur. Malicious tampering of the evaluation value by a human being is also assumed; the evaluation value does not necessarily represent the correct moving image reception quality.

Thus, in the related art example, although the evaluation value of the reception quality evaluation means is used, if an unreasonably low quality evaluation value is calculated, the service provider suffers an unreasonable loss and in contrast, if an unreasonably high quality evaluation value is calculated, the user suffers an unreasonable loss; this is a problem.

### SUMMARY OF THE INVENTION

It is therefore an object of the invention to provide a moving image reception quality determination apparatus that can fairly determine the reception quality of a moving image in moving image communication service with service charge determined based on the reception quality of a moving image.

To solve the above-described problem, according to a first aspect of the invention, there is provided a moving image reception quality determination apparatus comprising:

a moving image transmitter for transmitting a moving image;

a first moving image receiver for receiving the moving image transmitted by the moving image transmitter through a network;

a first moving image reception quality evaluation means for evaluating reception quality of the moving image of the first moving image receiver;

a second moving image receiver for receiving the moving image transmitted by the moving image transmitter through the network;

a second moving image reception quality evaluation means for evaluating reception quality of the moving image of the second moving image receiver; and

a determination machine for determining the reception quality of the moving image of the first moving image receiver based on comparison between a first evaluation value output by the first moving image reception quality evaluation means and a second evaluation value output by the second moving image reception quality evaluation means.

According to a second aspect of the invention, in the moving image reception quality determination apparatus as defined in the first aspect of the invention, the determination machine determines the reception quality based on a quality degradation index, a value of summing up differences between the first and second evaluation values over a specific time period.

According to a third aspect of the invention, in the moving image reception quality determination apparatus as defined in the first or second aspect of the invention, a service provider for providing moving image communication service between the moving image transmitter and the first moving image receiver contracts with the user using the first moving image receiver to receive a moving image for returning a part of service charge to the user based on the first evaluation value, and further contracts with a quality provider for managing the first moving image reception quality evaluation means, the second moving image reception quality evaluation means, and the determination machine for the quality provider to pay the amount determined based on the reception quality determined by the determination machine to the service provider.

### BRIEF DESCRIPTION OF THE DRAWINGS

FIG. 1 is a block diagram to show a configuration example of a moving image reception quality determination apparatus according to one embodiment of the invention;

FIG. 2 is a schematic representation to show an administration example of the moving image reception quality determination apparatus according to the embodiment; and

FIG. 3 is a block diagram to show a configuration example of a moving image reception quality determination apparatus in a related art.

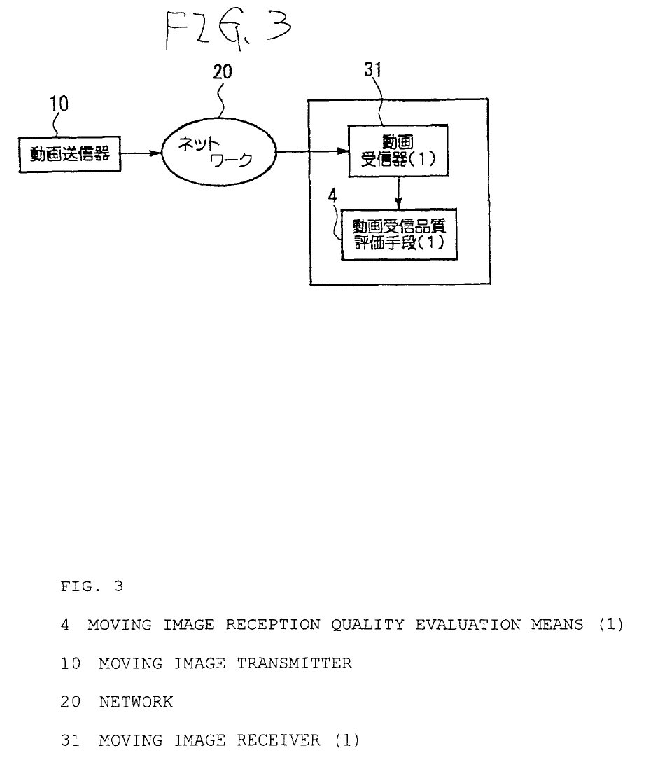

### DETAILED DESCRIPTION OF THE PREFERRED EMBODIMENTS

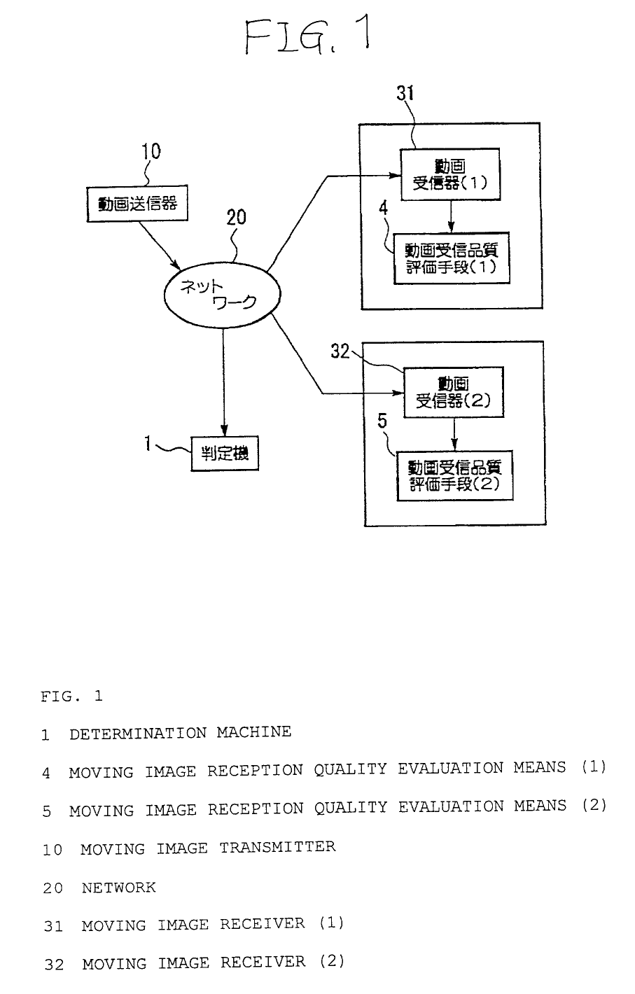

A preferred embodiment of the invention will be described with reference to the accompanying drawings. FIG. 1 is a block diagram to show a configuration example of a moving image reception quality determination apparatus according to one embodiment of the invention. A moving image transmitter 10 and a moving image receiver 31 are connected to a network 20 and moving image code transmitted by the moving image transmitter 10 is received at the moving image receiver 31. Moving image reception quality evaluation means 4 determines the moving image reception quality of the moving image receiver 31. A moving image receiver 32 is also connected to the network 20 and receives moving image code transmitted by the moving image transmitter 10. Moving image reception quality evaluation means 5 determines the moving image reception quality of the moving image receiver 32. Further, a determination machine 1 is connected to the network 20.

A first evaluation value calculated by the moving image reception quality evaluation means 4 and a second evaluation value calculated by the moving image reception quality evaluation means 5 are input to the determination machine 1 through the network 20. The determination machine 1 calculates the difference between the corresponding parts of the first and second evaluation values and calculates the sum total of the differences over a specific time period. This sum total will be referred to as “quality degradation index.”

The quality degradation index is the evaluation value difference between the two evaluation means over a specific time period. Thus, for example, assuming that the user uses the moving image communication service with the moving image receiver 31, the first evaluation value (namely, the reception quality in the moving image receiver 31) is compared relatively with the second evaluation value corresponding to the moving image receiver 32 as the reference. For example, when the quality degradation index takes a positive value, the moving image reception quality of the user is better; when the quality degradation index takes a negative value, the moving image reception quality of the user is worse.

However, even the second moving image reception quality evaluation means cannot completely evaluate the moving image reception quality on principle and the evaluation accuracy is limited as with the related art example described above. Originally, in the quality level contract, the quality level is converted into the scale of the charge and the essential point of establishing such service is that unreasonable feeling of the user is small.

If unreasonable feeling of the user is large, it is indispensable to solve the problem by setting a low charge, selecting a different service, any other provider, etc. In addition, a mechanism to beat artificial tampering of the evaluation value becomes important.

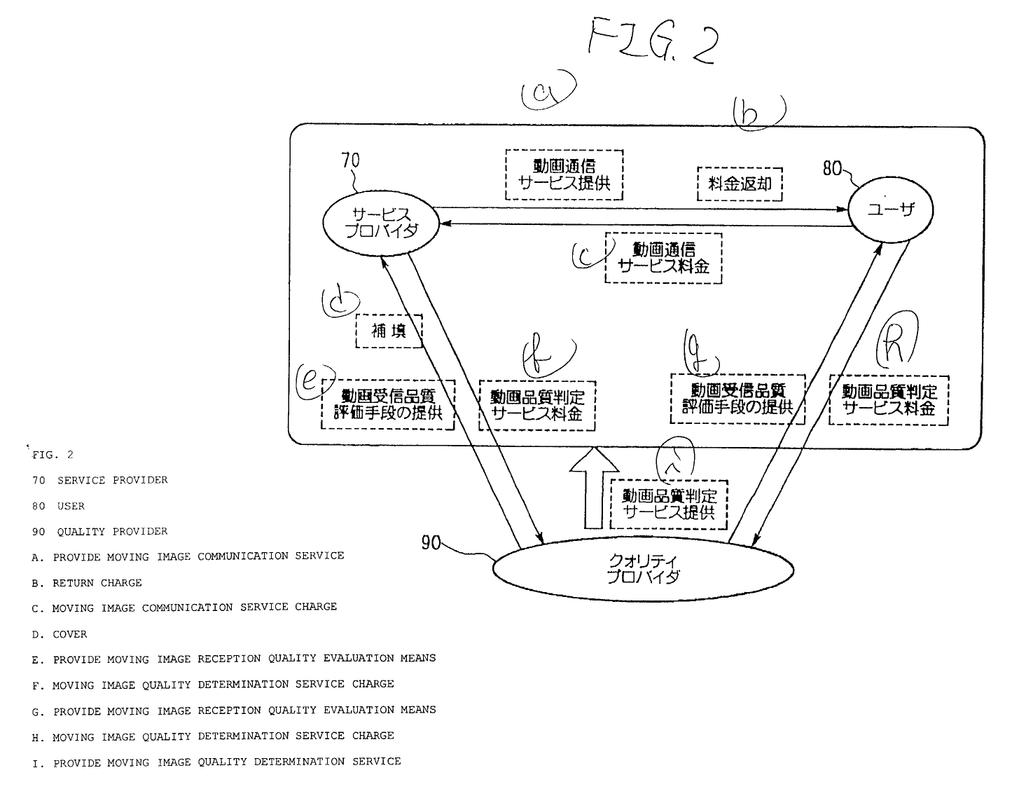

If the first evaluation value is unreasonable as in the problem described above, a clash of interests occurs between the user and the service provider. Thus, a third party (quality provider) is introduced. This will be discussed with FIG. 2, which is a schematic representation to show an administration example of the moving image reception quality determination apparatus according to the embodiment. In FIG. 2, a quality provider 90 provides the second moving image receiver 32, the first moving image reception quality evaluation means 4, the second moving image reception quality evaluation means 5, and the determination machine 1 for the purpose of fair evaluation of the moving image reception quality and covers settlement of the charge between a user 80 and a service provider 70 based on the quality degradation index. This provides moving image reception quality determination service.

Since the third party independent of interests provides moving image reception quality evaluation means, the problem of artificial tampering of the evaluation value can be solved by known security.

The costs required for administration of the service are obtained as service charges from the user 80 and the service provider 70. For example, the service provider 70 may contract with the quality provider 90 so that the charge for the moving image reception quality determination service is contained in the charge for the moving image communication service with the user 80. The user 80 receives the moving image communication service under the fair moving image reception quality determination service and thus bears the costs indirectly.

When the first evaluation value is unreasonable, if the service provider 70 makes unreasonable return, the quality provider 90 pays the charge corresponding to the unreasonable amount to the service provider 70, whereby the unreasonable feeling of the service provider 70 is canceled out. For example, often the user manages the quality of his or her moving image receiver itself. In this case, the quality provider 90 provides the second moving image receiver and thus the second moving image receiver can be regarded as the reference independent of the user and the evaluation value can be handled fairly from the positive or negative value of the quality degradation index.

Whether or not the quality provider 90 can operate good moving image reception quality determination service continuously depends on whether or not the quality degradation index can indicate the fair moving image reception quality. Therefore, motivation of pursuing technical performance of the moving image reception quality evaluation means provided by the quality provider 90 together with the costs and developing more accurate moving image reception quality evaluation means occurs. Particularly, whether or not the second moving image reception quality evaluation means can calculate the evaluation value close to the moving image reception quality of the user is the main point of providing the technique.

Whether or not the user 80 sustains unreasonable evaluation depends on the quality provided by the quality provider 90. Therefore, to make a quality level contract with the service provider for providing moving image communication service, the user 80 needs only to choose providing the moving image reception quality determination service or select the quality provider 90. If the user 80 has an unreasonable feeling, he or she can also cancel the contract, thereby canceling out the unreasonable feeling.

Thus, the fair moving image reception quality determination apparatus is provided according to the configuration in FIG. 2 by the administration method shown in FIG. 2.

Although the embodiment of the invention has been described in detail with reference to the accompanying drawings, specific configuration is not limited to the embodiment and if the design is changed, etc., without departing from the spirit and the scope of the invention, it is contained in the invention.

According to the first aspect of the invention, the fair moving image reception quality determination apparatus for suppressing unfair determination by the second moving image reception quality evaluation means rather than based on the unilateral evaluation result of only the first moving image reception quality evaluation means can be provided.

According to the second aspect of the invention, the stationary difference between the first moving image reception quality evaluation means and the second moving image reception quality evaluation means is corrected, whereby fairer moving image reception quality determination apparatus can be provided.

According to the third aspect of the invention, the user bears the charge responsive to the reception quality of the first moving image receiver, the service provider can earn a profit responsive to providing stable moving image reception quality, and the quality provider can earn more profit as the second evaluation value is closer to the first evaluation value, so that the mechanism for stable moving image reception quality and fair moving image reception quality determination can be provided.

What is claimed is:

1. A moving image reception quality determination apparatus comprising:
a moving image transmitter for transmitting a moving image;
a first moving image receiver for receiving the moving image transmitted by said moving image transmitter through a network;
a first moving image reception quality evaluator for evaluating reception quality of the moving image of said first moving image receiver;
a second moving image receiver for receiving the moving image transmitted by said moving image transmitter through said network;
a second moving image reception quality evaluator for evaluating reception quality of the moving image of said second moving image receiver; and
a determination machine for determining the reception quality of the moving image of said first moving image receiver based on comparison between a first evaluation value output by said first moving image reception quality evaluator and a second evaluation value output by said second moving image reception quality evaluator.

2. The moving image reception quality determination apparatus as claimed in claim 1 wherein said determination machine determines the reception quality based on a quality degradation index, a value of summing up differences between the first and second evaluation values over a specific time period.

3. The moving image reception quality determination apparatus as claimed in claim 1, wherein a service provider for providing moving image communication service between said moving image transmitter and said first moving image receiver contracts with a user using said first moving image receiver to receive a moving image for returning a part of service charge to the user based on the first evaluation value; and
wherein contracts with a quality provider for managing said first moving image reception quality evaluator, said second moving image reception quality evaluator, and said determination machine for the quality provider to pay an amount determined based on the reception quality determined by said determination machine to the service provider.
